(19) United States
(12) Patent Application Publication
(10) Pub. No.: US 2014/0326839 A1
(43) Pub. Date: Nov. 6, 2014

(54) SUPPORT FOR POSITIONING AN ARTICLE IN A FREE STANDING MANNER

(71) Applicant: Keizus, Inc., Richmond Hill (CA)

(72) Inventors: Alexander Zouev, Ontario (CA); Maksym Petrenko, Richmond Hill (CA); Vitaliy Petrenko, Thornhill (CA)

(21) Appl. No.: 13/875,189

(22) Filed: May 1, 2013

(51) Int. Cl. F16M 11/18; F16M 11/38

(52) U.S. Cl. CPC F16M 11/18; F16M 11/38
USPC 248/122.1

(57) ABSTRACT

An apparatus for supporting an article in a free standing manner so that the article can be used in a hands free manner, i.e., without an individual supporting the article or the support apparatus. The apparatus includes a support having a body and a plurality of appendages. The support is configured to position an article in a free standing manner so that the article can be used by an individual without the individual holding the article. The body has a plurality of connection areas. Preferably, each of the plurality of appendages has at least one connection area. Preferably, the support includes four appendages. Preferably, the appendages are connected to the body in such manner as to allow the appendages and body to be positioned in a multitude of different positions to allow the support to support numerous different articles and allow the support to be mounted on a multitude of differently contoured surfaces.

### FIELD OF THE INVENTION

The present invention is directed to a support for positioning an article so that the article can be used by an individual in a hands free manner (i.e., without an individual supporting the article or the support) where one or more components of the support can be readily manipulated to assume a multitude of positions to allow the support to accommodate numerous different shaped and sized articles and further allow the support to be mounted on a multitude of different mounting surfaces.

### BACKGROUND OF THE INVENTION

Numerous devices have been developed to support various articles to assist an individual in the use of the article. U.S. Pat. Nos. 7,891,615 and 8,197,149 disclose tri-pod supports for supporting and positioning cameras and other devices to assist an individual in the use of the device supported by the tri-pod. U.S. Patent Publication No. 2008/0265111 also discloses a tri-pod support for supporting and positioning cameras and other devices to assist an individual in the use of the device supported by the tri-pod. These devices suffer from a number of inherent disadvantages due to their respective designs. For example, the tri-pod supports cannot be readily reconfigured to allow the support to accommodate a multitude of different shaped and sized objects. Further, these tri-pod supports can only be mounted on (i.e., attached to, rested on or otherwise secured to a mounting surface) a very limited number of surfaces. Moreover, none of the legs of these tri-pod supports can be manipulated such that one or more of the legs grip the article supported by the tri-pod support.

U.S. Design Pat. No. 658,047 illustrates a “gadget grip.” This device also has several inherent limitations. For example, the length of the eight (8) extensions of the device disclosed in the '047 patent cannot be varied. Further, none of the eight (8) extensions can be detached from the center section of the device. Moreover, none of the eight (8) extensions can rotate relative to the center section.

Hence, there exists a need for a more versatile support able to accommodate a greater variety of objects that vary in size, shape, weight, etc. There further exits a need for a more versatile support that can be mounted on a greater number of surfaces.

### OBJECTS AND SUMMARY OF THE INVENTION

An object of the present invention is to provide a novel and unobvious support apparatus.

Another object of a preferred embodiment of the present invention is to provide a support apparatus having a plurality of components that can be readily manipulated to allow the support apparatus to readily accommodate a multitude of articles of varying size, shape, weight, etc.

A further object of a preferred embodiment of the present invention is to provide a support apparatus having a plurality of components that can be readily manipulated to allow the support apparatus to be readily mounted on (i.e., attached to, rested on or otherwise secured to a mounting surface) a multitude of differently configured, contoured and/or oriented mounting surfaces.

Still a further object of a preferred embodiment of the present invention is to provide a support apparatus having a plurality of components the size of which can be readily varied to increase the number of different articles the support apparatus can support.

Yet another object of a preferred embodiment of the present invention is to provide a support apparatus having a plurality of components the size of which can be readily varied to increase the number of mounting surfaces on which the support apparatus can be mounted.

Still a further object of a preferred embodiment of the present invention is to provide a support apparatus having plurality of components interconnected in such a manner as to maximize the freedom of movement of one or more of the components relative to one or more other components of the support apparatus.

Yet still another object of a preferred embodiment of the present invention is to provide a support apparatus having a body and a plurality of appendages interconnected to the body such that each appendage has at least two and preferably three degrees of rotational freedom relative to the body.

Yet a further object of a preferred embodiment of the present invention is to provide a support apparatus having a plurality of links that can be readily interconnected with the body or another link to readily vary the size of the support apparatus and/or the size of one or more appendages of the support apparatus.

Another object of a preferred embodiment of the present invention is to provide a support apparatus having a plurality of links that can be readily interconnected to another link such that each link has at least two and preferably three degrees of rotational freedom relative to the other link.

A further object of a preferred embodiment of the present invention is to provide a support apparatus having a body and a plurality of appendages where one or more of the appendages can grip an article supported by the support apparatus when the appendage is oriented in a first position and serve as a support leg contacting a mounting surface when the appendage is oriented in a second position.

A still further object of a preferred embodiment of the present invention is to provide a support apparatus having a body and four appendages where one or more of the appendages is interconnected to the body by a non-hollow ball and a socket receiving the non-hollow ball (i.e., a ball free of recesses or depressions in the portion of the outer surface of the ball engaged by the socket).

Yet still another object of a preferred embodiment of the present invention is to provide a support apparatus with a body and four appendages interconnected to the body where the body includes a body section and a neck section that is moveable relative to the body section.

Still a further object of a preferred embodiment of the present invention is to provide a versatile support apparatus with an adjustable clamping member permitting a plurality of different sized or shaped articles to be securely connected to the support apparatus.

It must be understood that no one embodiment of the present invention need include all of the aforementioned objects of preferred embodiments of the present invention. Rather, a given embodiment may include one or none of the aforementioned objects. Accordingly, these objects are not to be used to limit the scope of the claims of the present invention.

In summary, one preferred embodiment of the present invention is directed to an apparatus for supporting an article in a free standing manner so that the article can be used by an individual without the individual supporting the article. The apparatus includes a support having a body and a plurality of appendages. The support is configured to position an article in a free standing manner so that the article can be used by an individual without the individual holding the article. The body has a plurality of connection areas. Each of the plurality of appendages has at least one connection area so that each of the plurality of appendages can be detachably connected to one of the plurality of connection areas of the body. At least one of the plurality of appendages is connected to the body so that the at least one of the plurality of appendages can be moved between a first position and a second position. In the first position, the at least one of the plurality of appendages grips a portion of the article and in the second position the at least one of the plurality of appendages contacts a surface on which the support is mounted.

Another preferred embodiment of the present invention is directed to an apparatus for supporting an article in a free standing manner so that the article can be used by an individual without the individual supporting the article. The apparatus includes a support having a body and a plurality of appendages. The support is configured to position an article in a free standing manner so that the article can be used by an individual without the individual holding the article. The body has a plurality of connection areas. Each of the plurality of appendages has at least one connection area so that each of the plurality of appendages can be detachably connected to one of the plurality of connection areas of the body. The plurality of connection areas of the body and the plurality of connection areas of the appendages is configured so that the position of the body and the appendages can be readily varied to allow the support to support at least one of the following: (i) a plurality of articles where each of the plurality of articles has a different size; and (ii) a plurality of articles where each of the plurality of article has a different shape.

A still further preferred embodiment of the present invention is directed to an apparatus for supporting an article in a free standing manner so that the article can be used by an individual without the individual supporting the article. The apparatus includes a support having a body and a plurality of appendages. The support is configured to position an article in a free standing manner so that the article can be used by an individual without the individual holding the article. The body has a plurality of connection areas. Each of the plurality of appendages has at least one connection area so that each of the plurality of appendages can be connected to one of the plurality of connection areas of the body. The plurality of connection areas of the body and the plurality of connection areas of the appendages is configured so that the position of the body and the appendages can be readily varied to vary the number of contact junctures between the support and a support structure upon which the support is mounted. At least one of the plurality of appendages includes a plurality of detachably connected links so that the length of the at least one of the plurality of appendages can be readily varied.

Another preferred embodiment of the present invention is directed to an apparatus for supporting an article in a free standing manner so that the article can be used by an individual without the individual supporting the article. The apparatus includes a support having a body and a plurality of support appendages such that at least one of the plurality of support appendages has at least two rotational degrees of freedom relative to the body. The support is configured to position an article in a free standing manner so that the article can be used by an individual without the individual holding the article. Each of the plurality of support appendages is adjustable relative to the body to allow an individual to vary the configuration of the support. At least one of the plurality of support appendages is configured to be moveable between a first support position and a second support position. In the first support position, the at least one of the plurality of support appendages has at least one more contact juncture with a first support structure on which the support is mounted than when the at least one of the plurality of support appendages is in the second support position.

### BRIEF DESCRIPTION OF THE DRAWINGS

FIG. 1 is an exploded, perspective view of a preferred form of the present invention.

FIG. 2a is a perspective view of the body section of a preferred formed of the present invention.

FIG. 2b is a side elevation view of the body section of a preferred formed of the present invention.

FIG. 3a is a side elevation view of a link of an appendage with an anti-slip cover of a preferred form of the present invention.

FIG. 3b is a side elevation view of a link of an appendage without the anti-slip cover that in the preferred form of the present invention connects to the link in FIG. 3a.

FIG. 3c is a side elevation view of an alternative form of a link of an appendage without the anti-slip cover of a preferred form of the present invention.

FIG. 3d is a side elevation view of the link depicted in FIG. 3c with an anti-slip cover.

FIG. 4a is a front elevation view of the body of the preferred form of the present invention.

FIG. 4b is a cross-sectional view taken along the lines A-A in FIG. 4a.

FIG. 4c is a side elevation view of the body of the preferred form of the present invention.

FIG. 4d is a cross-sectional view taken along the lines B-B in FIG. 4c.

FIG. 5a is a perspective view taken from the right, front side of a clamping member that may be used with the preferred form of the present invention.

FIG. 5b is a perspective view taken from the rear, left side of the clamping member illustrated in FIG. 5a.

FIG. 5c is a perspective sectional view of the clamping member illustrated in FIG. 5a.

FIG. 5d is an exploded, perspective sectional view of the clamping member illustrated in FIG. 5a.

FIG. 5e is a perspective view of one element of the clamping member illustrated in FIG. 5a.

FIG. 5f is a perspective view of another element of the clamping member illustrated in FIG. 5a.

FIG. 5g is a perspective view of a further element of the clamping member illustrated in FIG. 5a.

FIG. 6 is a perspective view of a preferred form of the present invention oriented in one of numerous possible different configurations with the clamping member illustrated in FIG. 5a positioned above the point of attachment to the preferred form of the present invention.

FIG. 7 is a perspective view of a preferred form of the present invention in another of numerous possible different configurations with the clamping member illustrated in FIG. 5a attached to the preferred form of the present invention.

FIG. 8 is a perspective view of a preferred form of the present invention in another of numerous possible different configurations with a camera being supported by the preferred form of the present invention.

FIG. 9 is a perspective view of a preferred form of the present invention in another of numerous possible different configurations with a camera being supported by the preferred form of the present invention.

FIG. 10a is a perspective view of the preferred form of the present invention mounted on the back of a chair.

FIG. 10b is a perspective view of the preferred form of the present invention mounted on the back of another type of chair where the preferred form of the present invention takes a form different from that illustrated in FIG. 10a.

FIG. 11 is a perspective view of the preferred form of the present invention securely holding a tablet.

FIG. 12 is a perspective view of the preferred form of the present invention securely holding an electronic device (e.g., smartphone, camera, etc.).

FIG. 13 is a perspective view of the preferred form of the present invention in another of numerous possible different configurations with the clamping member illustrated in FIG. 5a securely holding an electronic device where each of the appendages of the preferred form of the present invention includes a single link.

FIG. 14 is a perspective view of the preferred form of the present invention in another of numerous possible different configurations with the clamping member illustrated in FIG. 5a securely holding an electronic device where each of the appendages of the preferred form of the present invention includes a single link.

### DETAILED DESCRIPTION OF THE PREFERRED EMBODIMENTS OF THE INVENTION

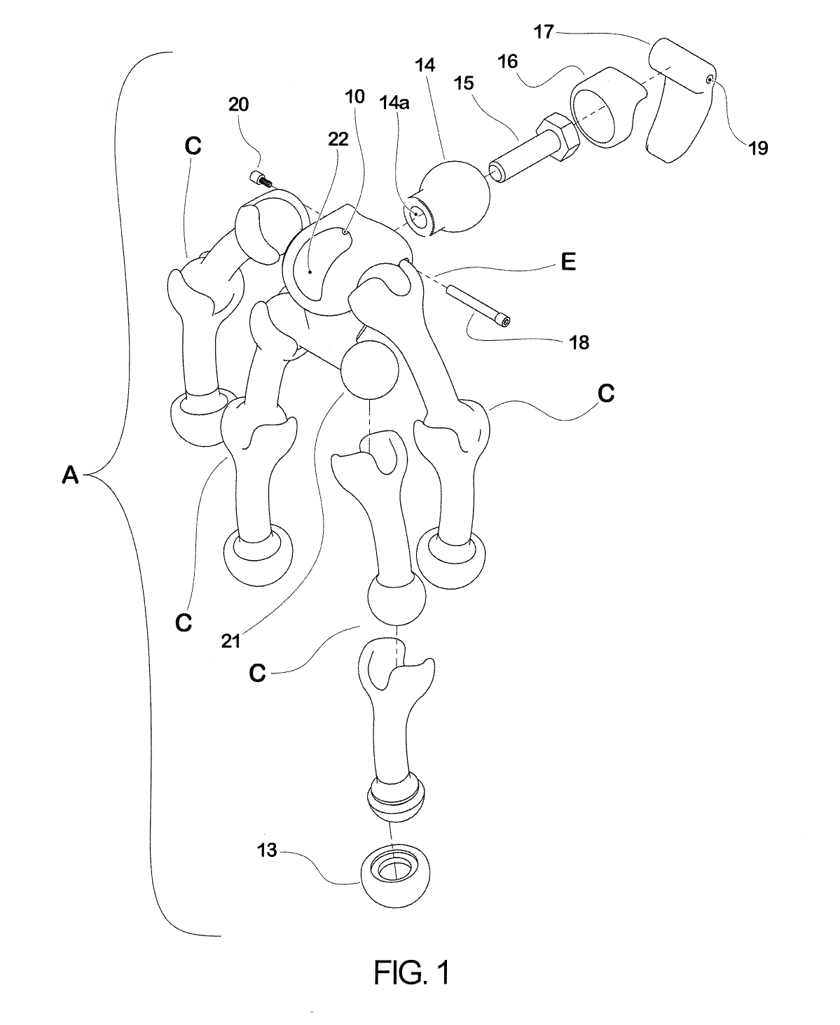

The preferred forms of the invention will now be described with reference to FIGS. 1-14. The appended claims are not limited to the preferred forms and no term and/or phrase used herein is to be given a meaning other than its ordinary meaning unless it is expressly stated otherwise.

### FIGS. 1 Through 14

Referring to FIGS. 1 to 4, an exploded view of support A formed in accordance with a preferred embodiment of the present invention is illustrated. Support A includes a body B and four appendages C. While the preferred form of support A includes four appendages C, the number of appendages may be varied as desired. In the preferred form, each of the appendages C has the same composition.

Preferably, support A is configured to position an article in a free standing manner so that an individual can use the article held or supported by support A without the individual holding the article or support A, i.e., the individual can use the article in a “hands free” manner. It will be readily understood that support A can be used to position a multitude of articles in a free standing manner. The articles that can be used with support A include but are not limited to books, pamphlets, magazines, pictures, paintings, cameras, smartphones, video recorders, tablets, hand-held speakers and portable displays.

Referring to FIG. 1, the body B preferably includes a body section 10, a neck section 14, an attachment member 15, a cam 16 and a lever 17. The neck section 14 includes a spherical ball joint having an opening 14a extending there through to receive attachment member 15 having external or male threads. Preferably, the attachment member is a threaded bolt or screw. However, it will be readily appreciated that any suitable attachment device may be used.

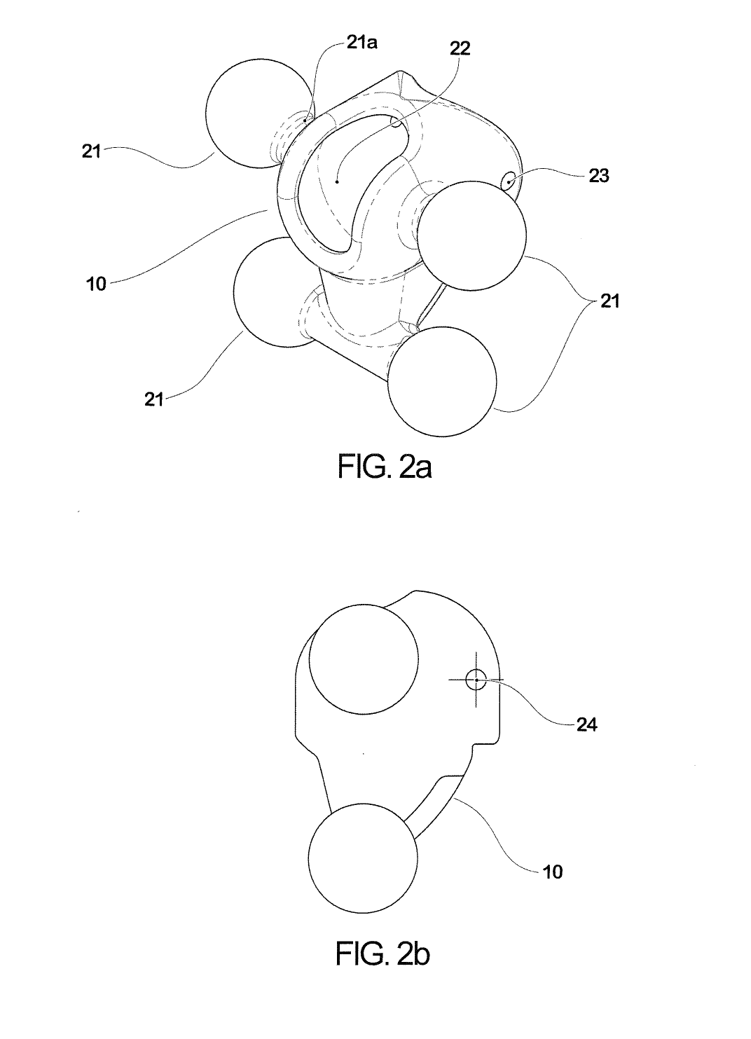

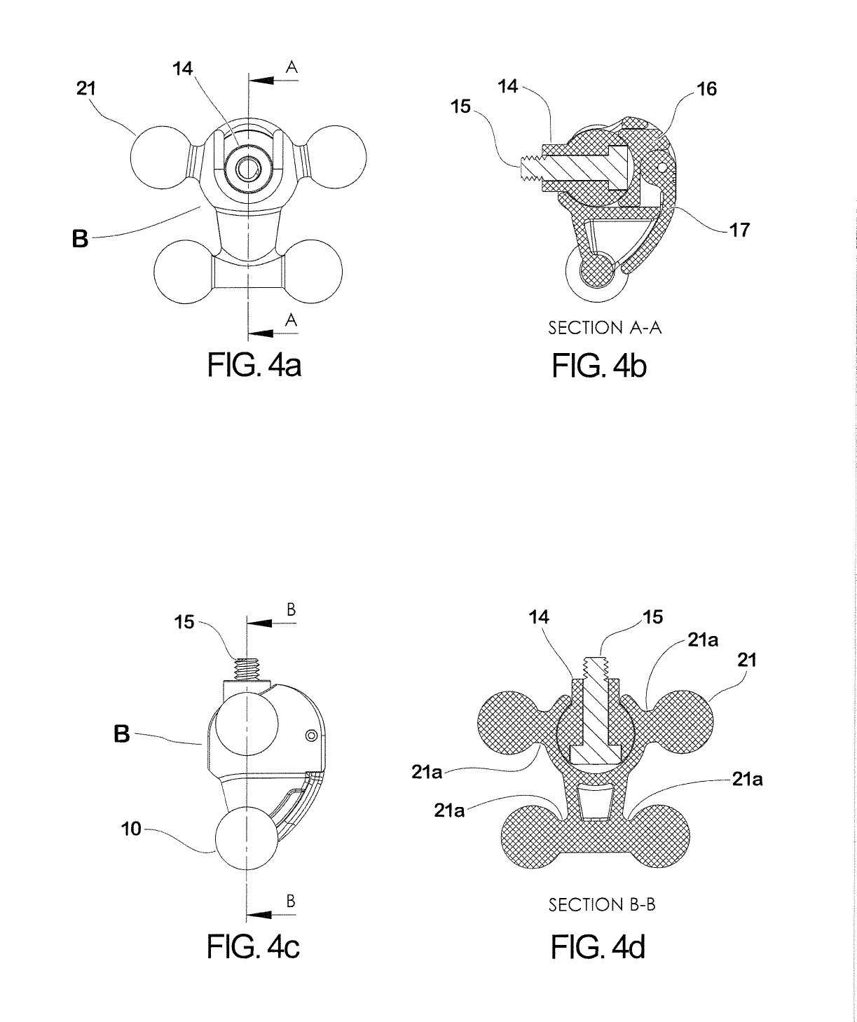

Referring to FIGS. 2a and 2b and FIGS. 4a through 4d, neck section 14 is positioned in a hollow cavity 22 of body section 10 such that the threaded portion of attachment member 15 extends through the enlarged opening at one end of hollow cavity 22 of body section 10. The enlarged opening of hollow cavity 22 and the ball joint portion of the neck section 14 allow the neck section 14 to move relative to the body section 10. Body section 10 includes two small and oppositely disposed openings 23 and 24. In the preferred form, the neck section 14 can move ninety degrees relative to body section 10. FIGS. 4a and 4b illustrate neck section 14 in one extreme position relative to body section 10. FIGS. 4c and 4d illustrate neck section 14 in the other extreme position relative to body section 10. Neck section 14 can be oriented in any position between the two extreme positions illustrated in FIGS. 4a and 4c. The ball joint portion of neck section 14 provides the neck section 14 with unlimited rotational freedom relative to body section 10 about the longitudinal axis of attachment member 15, i.e., neck section 14 is free to rotate relative to body section 10 three hundred and sixty degrees in either direction about the longitudinal axis of attachment member 15.

Referring to FIGS. 1 and 4a through 4d, the neck section 14 is maintained in a particular position relative to body section 10 by cam 16 and lever 17. Lever 17 is pivotally attached to body section 10 by mounting assembly E. Mounting assembly E includes a pin 18 and a locking bolt 20. The locking bolt 20 and pin 18 each include an enlarged head and a shaft. The end of the shaft of pin 18 has an internally threaded bore to receive the externally threaded end of the shaft of locking bolt 20. The elongated shaft of pin 18 extends into opening 23 in body section 10 and passes through a bore or passageway 19 in the upper portion of lever 17. The enlarged head of pin 18 is larger than the corresponding opening 23 in body section 10. The shaft of locking bolt 20 extends through the opening 24 and is screwed into the internally threaded bore of the shaft of pin 18. The enlarged head of bolt 20 is larger than opening 24 in body section 10.

When lever 17 is in the position shown in FIG. 4b, neck section 14 cannot move relative to body section 10 due to the retaining force exerted on the ball joint portion of neck section 14 by cam 16 and lever 17. To adjust the position of neck portion 14 relative to body section 10, lever 17 is lifted upward such that the lower portion (free end) of the lever 17 moves away from body section 10. Due to the eccentricity of the lever and cam design, this movement relieves the retaining force exerted on the ball joint portion of neck section 14 by the lever 17 and cam 16 to allow the position of the neck section 14 to be adjusted relative to body section 10.

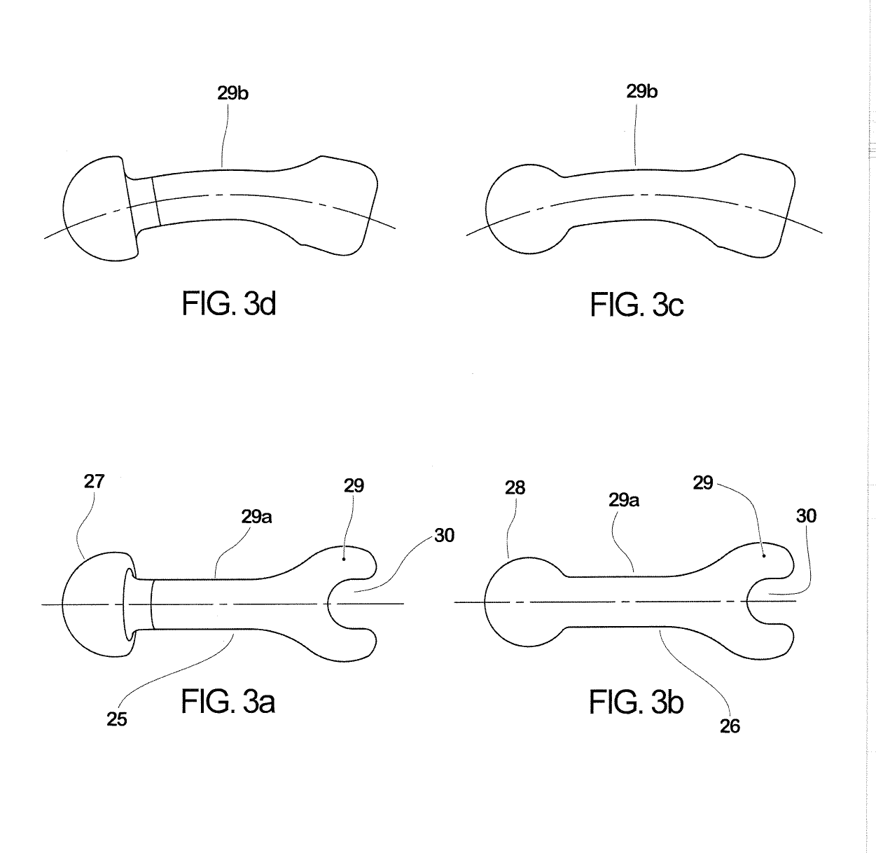

Body section 10 preferably has four attachment areas each of which includes a ball joint 21 having a reduced connecting portion 21a. Referring to FIGS. 1, 6, 7, each appendage C is detachably connected to one of the four ball joints 21. In the preferred form, each appendage C has a similar structure and includes at least two links 25 and 26. Referring to FIGS. 3a and 3b, each of the links 25 and 26 has a ball joint 28 and a socket 29. The socket 29 is connected to ball joint 28 by mid-section 29a. Preferably, mid-section 29a has a length equal to or greater than the length of each of ball joint 28 and socket 29. Each socket 29 includes a pair of oppositely disposed slots or recesses 30.

The only difference between link 25 and link 26, in the preferred form of the present invention, is that link 25 has an anti-slip cover 27 mounted over the ball joint 28. The anti-slip cover can be formed from a thermoplastic elastomer (TPE) or any other material that will adequately prevent link 25 from slipping relative to a contact juncture between link 25 and a support surface on which support A is mounted or between link 25 and an article being supported by support A. Preferably, the anti-slip cover is readily removable from the ball joint 28 of link 25. Due to the fact that links 25 and 26 have an identical design once the anti-slip cover on link 25 is removed, links 25 and 26 can be readily interchanged.

FIGS. 3c and 3d illustrate a modified form of link 25 and link 26 in which the only difference is that the mid-section 29b is arcuate to improve the gripping action of the link.

Links 25 and 26 are detachably connected to each other by inserting ball 28 of link 26 into socket 29 of link 25. Link 25 when connected to link 26 has three degrees of rotational freedom relative to link 26. Further, link 25 has unlimited rotational freedom relative to link 26 about the longitudinal axis of link 25, i.e., link 25 is free to rotate relative to link 26 three hundred and sixty degrees in either direction about the longitudinal axis of link 25.

Socket 29 of each of links 26 of each of the four appendages C is detachably connected to one of the four ball joints 21. Each link 26, when connected to the corresponding ball joint 21, has three degrees of rotational freedom relative to body section 10. Further, each link 26 has unlimited rotational freedom relative to body section 10 about the longitudinal axis of link 26, i.e., each link 26 is free to rotate relative to body section 10 three hundred and sixty degrees in either direction about the longitudinal axis of link 26.

Referring to FIGS. 3a and 3b, opposing slots 30 of each socket 29 are configured to allow for easy attachment and/or detachment of one link to another link or to the body section 10. Further, opposing slots 30 are configured to ensure a reliable and predictable motion range. Specifically, each socket 29 is designed such that the connection is limited to allow just enough motion to satisfy full functionality and limit dislocation while providing sufficient normal force in the socket to induce enough creep between the surfaces in contact to maintain ample hold pressure. The slots 30 hug the ball joint 28 of an adjacent link or ball joint 21 of body section 10 and have sufficient width to receive a portion of the mid-section 29a of a connected link in the slot 30. Slots 30 are also sized to receive connecting portion 21a of ball joint 21. The ball joint and socket arrangement of the preferred form of the present invention allows for 180 degrees of pivoting axial motion of each link relative to a connected part (i.e., either another link or the body section).

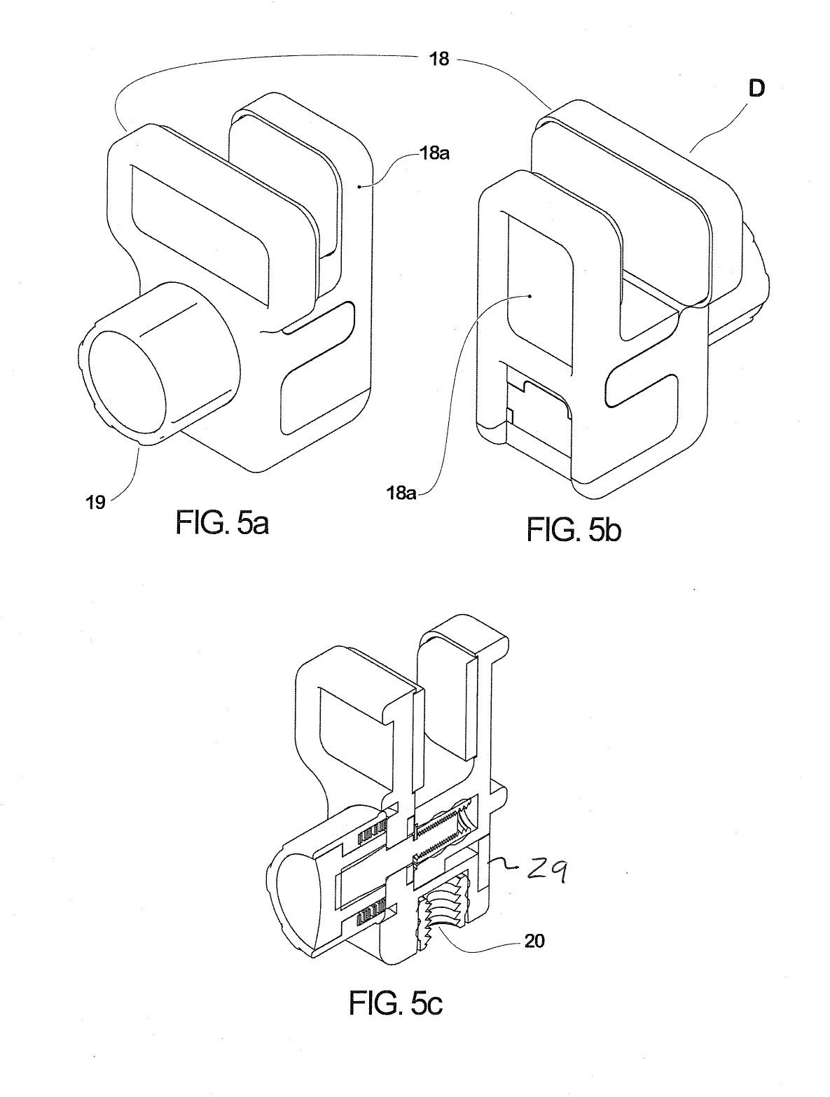

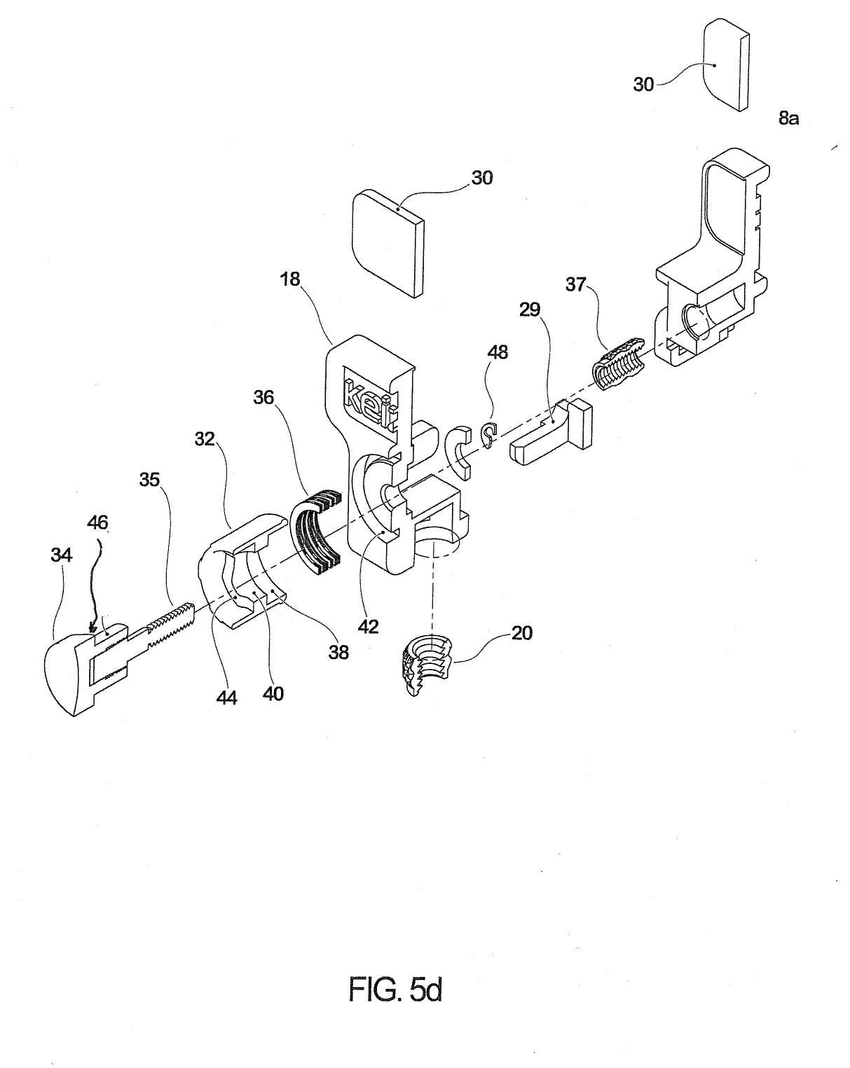

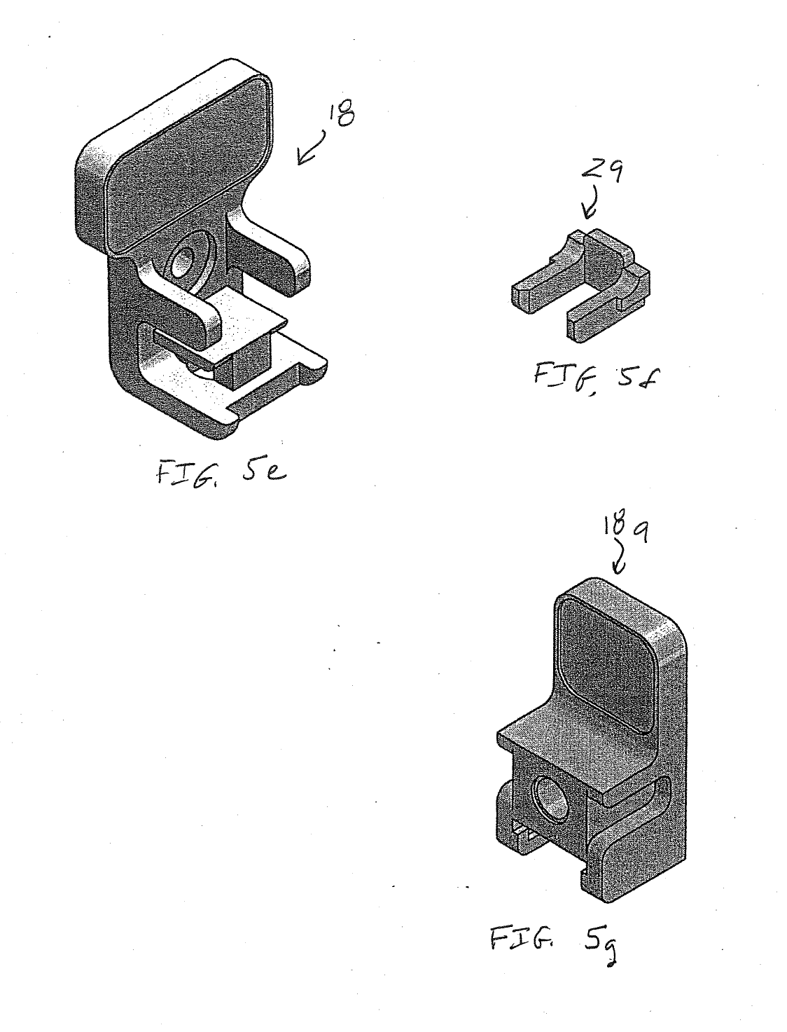

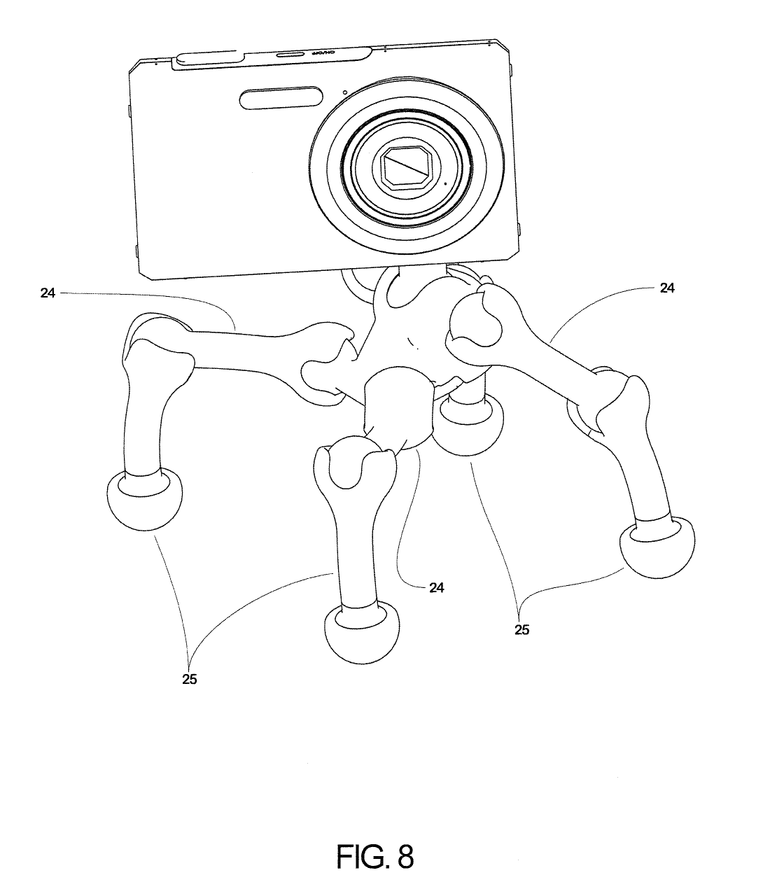

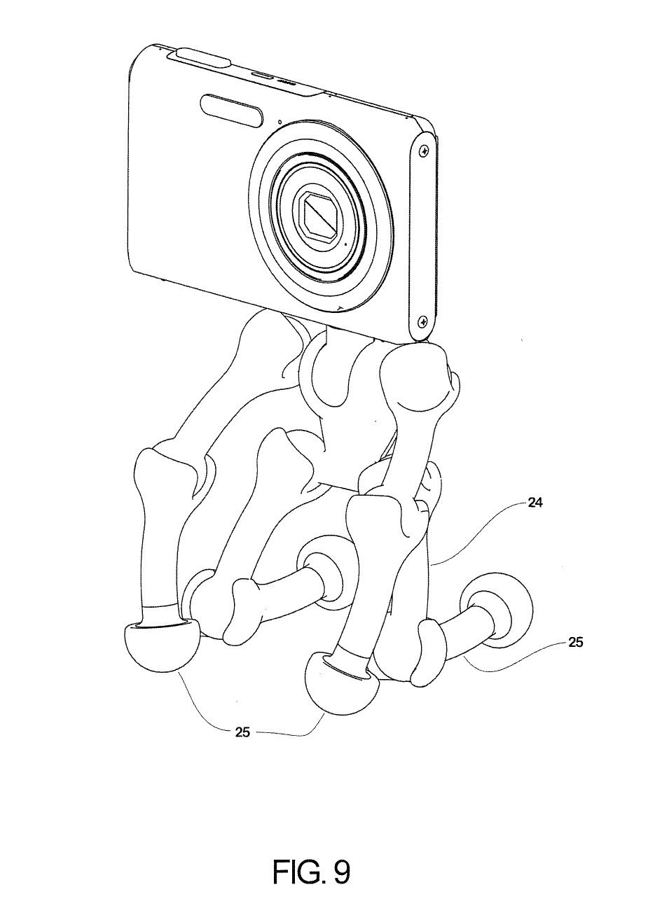

As seen in FIGS. 5c, 6 and 7, a clamping member D having female threads 20 may be readily screwed onto the male threads of attachment member 15 to detachably secure clamping member D to support A. Alternatively, as seen in FIGS. 8 and 9, the article supported by support A can be threaded directly onto attachment member 15 provided that the article has mating female threads.

Referring to FIGS. 5a through 5d, the clamping member D includes a pair of adjustable clamps seats 18, 18a and an adjustment member 19 which an individual turns to adjust the space between the clamp seats 18, 18a. FIGS. 5a through 5c illustrate clamp member D where the clamp seats 18, 18a are spaced as close as possible to each other. Referring to FIG. 5d, the inner surfaces of the clamp seats 18, 18a may be lined with a cushioning member 30 formed from a suitable material to prevent damage to the article being held by the clamping member D.

As seen in FIGS. 5a through 5d, 5e and 5g, clamp seat 18 is configured to interlock and be moveable relative to clamp seat 18a. Referring to FIG. 5f, stop member 29 is fixed to clamp seat 18 such that stop member 29 cannot move relative to clamp seat 18. Referring to FIG. 5c, stop member 29 acts as a stop by limiting movement of clamp seat 18a. More specifically, clamp seat 18a cannot move any further away from clamp seat 18 once clamp seat 18a comes into contact with stop member 29.

Adjustment member 19, referring to FIG. 5d, includes an outer knob 32 and an inner core 34 having a threaded end 35 at least a portion of which is always in engagement with mating threaded portion 37 of clamp seat 18a. A wave spring 36 extends into outer knob 32 and engages substantially planar surface 38 of annular rib 40 formed in outer knob 32. The other end of wave spring 36 extends into annular cavity 42 formed in the clamp seat 18. Annular rib 40 has a pair of cam lobes formed in vertically extending surface 44 that are associated with a pair of cam lobes formed in vertically extending surface 46 of inner core 34.

Inner core 34 is fixed relative to clamp seat 18 by a locking ring 48. The threaded end of inner core 34 engages the corresponding threaded portion 37 of clamp seat 18a. The wave spring 36 urges surface 44 of outer knob 32 into contact with surface 46 of inner bore 34. Hence, when an individual turns outer knob 32 in a clockwise direction, inner core 34 will turn in a clockwise direction causing the clamp seat 18 to move towards clamp seat 18a. When an individual turns outer knob 32 in a counterclockwise direction seat 18 will move away from clamp seat 18a.

The clamping member D is configured to prevent damage to the article being held. Specifically, clamping member D is designed to restrict the torque that the user can apply when turning outer knob 32 to close the clamp seats 18 and 18a to engage at least a portion of the article. When over torqued, spring 36 is compressed causing surface 44 of outer knob 32 to move away from surface 46 of inner core 34 which in turn allows outer knob 32 to slip on or turn relative to inner core 34. Further, when the outer knob 32 is unwound to a point that the clamping member D could break (since the thread portions 35 and 37 are always engaged), the outer knob 32 will slip on the inner core 34 in the reverse direction. The cam lobes preferably have different angles for the two opposite directions of movement (i.e., clockwise and counterclockwise), such that the outer knob 32 does not slip on inner core 34 when the article is being released from the clamping member D.

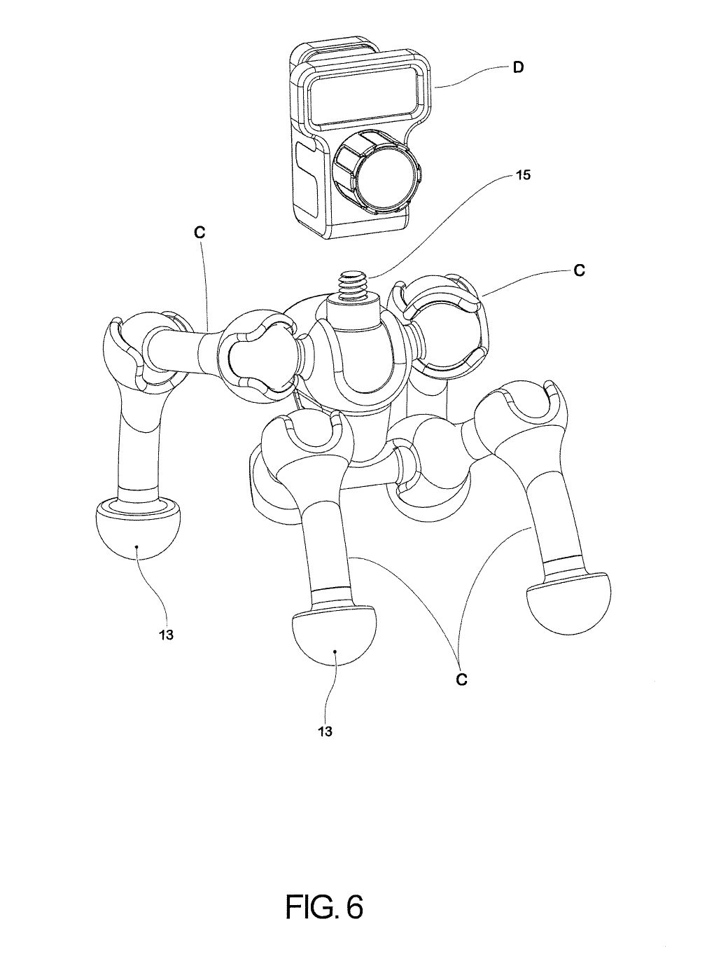

The appendages C and body B can be readily manipulated due to the connecting joints so that support A can assume a multitude of different configurations to allow support A to hold a variety of different objects and/or be mounted on a multitude of different supporting surfaces. FIGS. 6 to 9, 10a, 10b and 11 to 14 illustrate just a few of the numerous ways support A can be deployed.

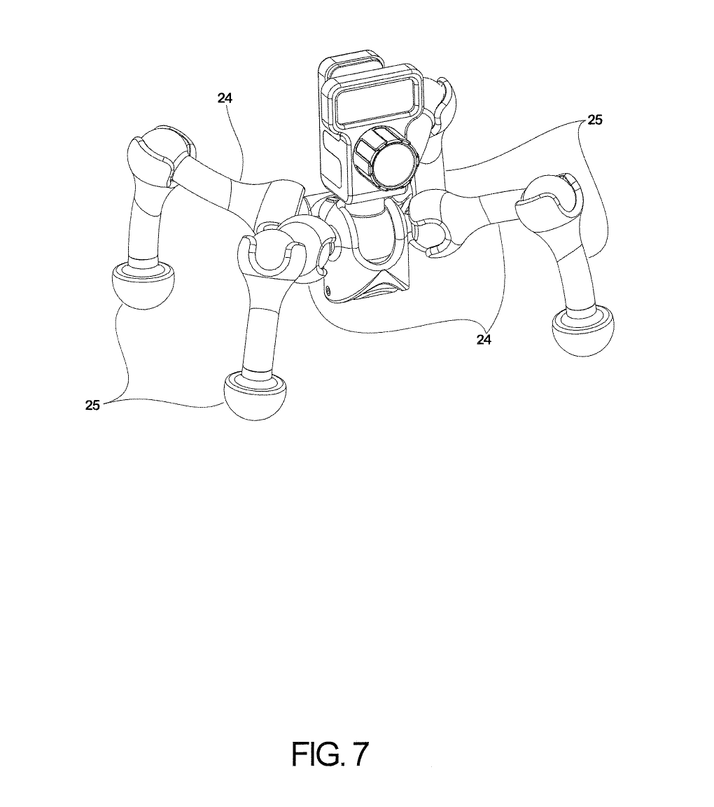

FIGS. 6 and 7 illustrate two different configurations for support A where body B and each of the appendages C assume a different position in FIG. 6 than in FIG. 7. FIGS. 6 and 7 illustrate the use of clamping member D with support A. In FIG. 7, support A is configured such that it has five contact junctures with the support surface, one formed by each of the four appendages C and one formed by body B. Support A, as configured in FIG. 6, only has four contact junctures with the support surface, one formed by each leg. FIGS. 8 and 9 again illustrate two different configurations for support A where body B and each of the appendages C assume a different position in FIG. 8 than in FIG. 9. In FIGS. 8 and 9, the article being held is directly connected to support A via attachment member 15. In FIG. 9, support A is configured such that there are six contact junctures with the supporting surface, one formed by each of the front appendages and two formed by each of the rear appendages.

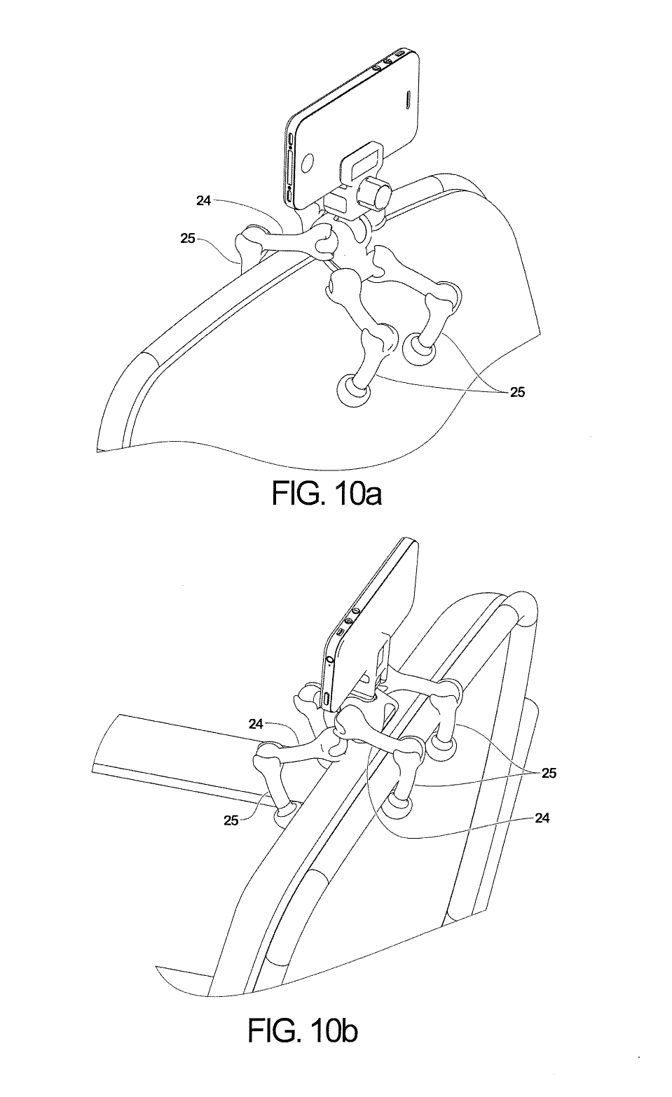

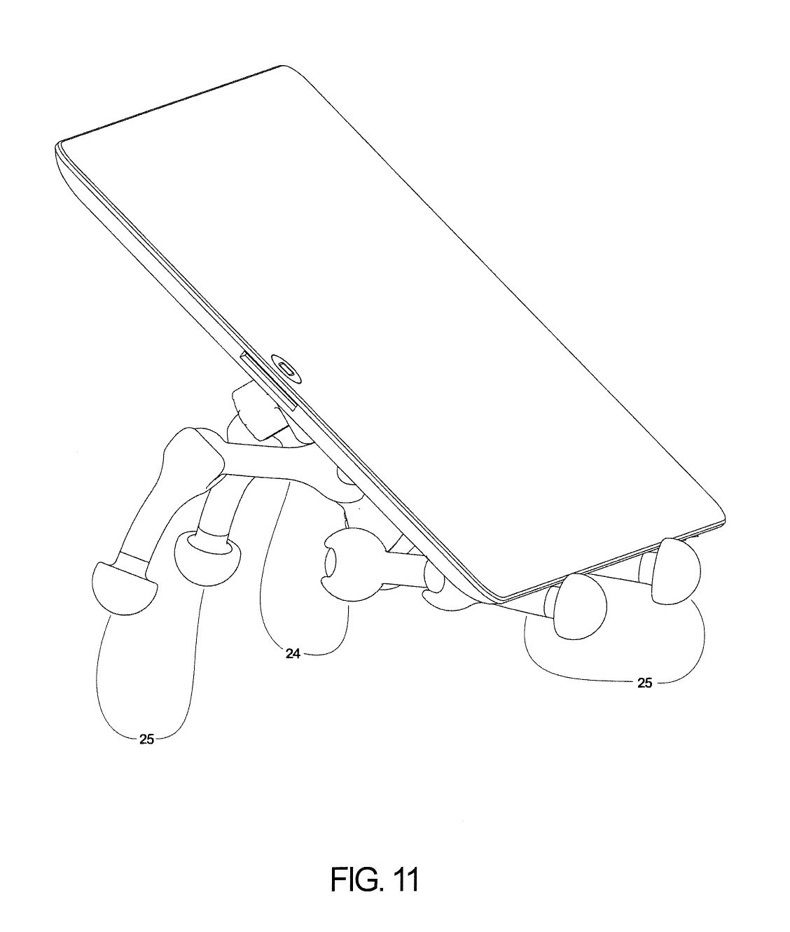

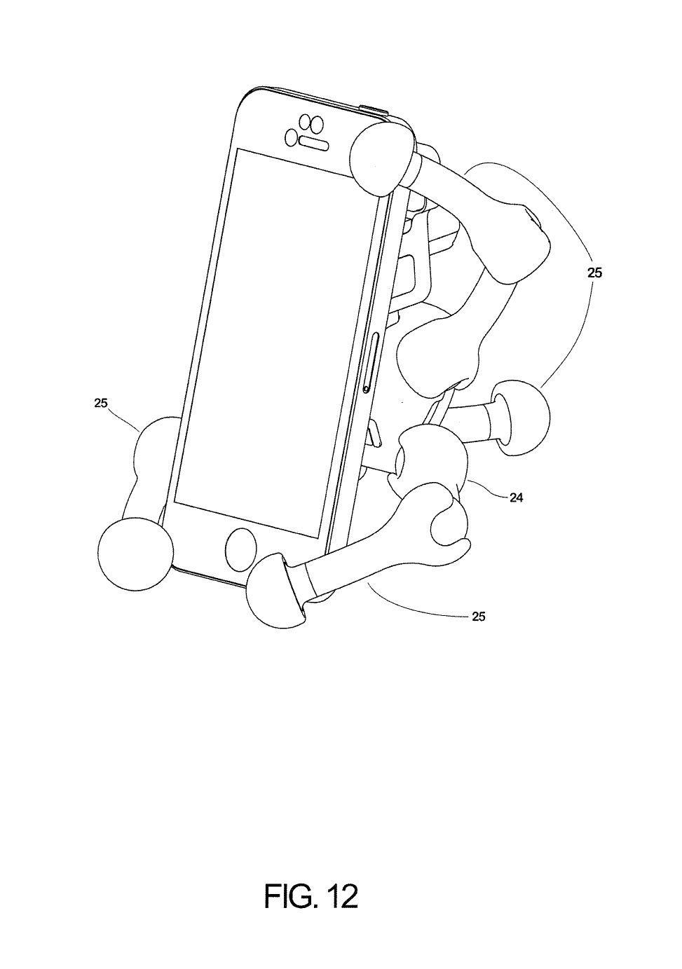

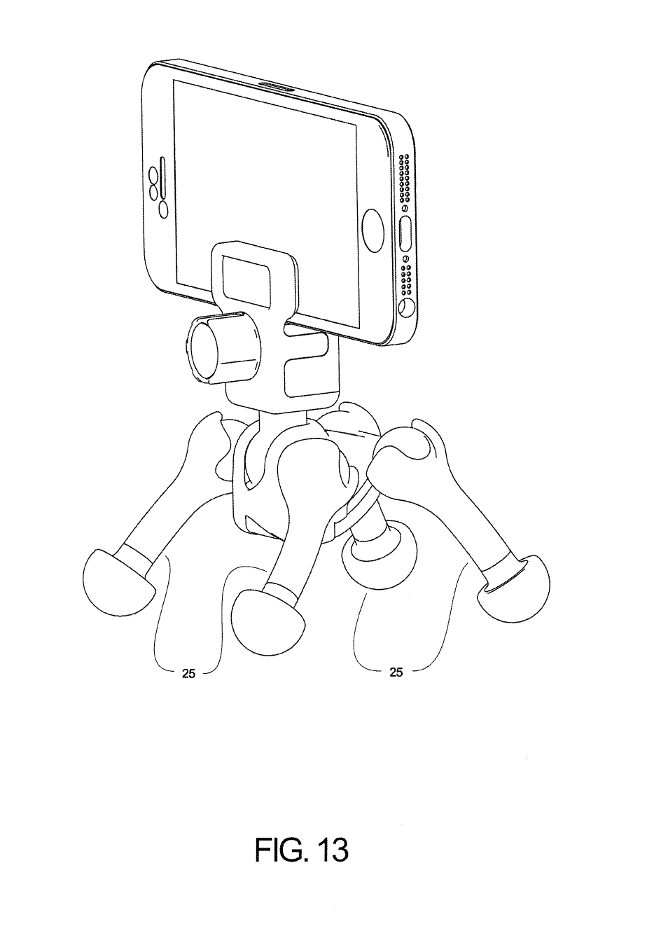

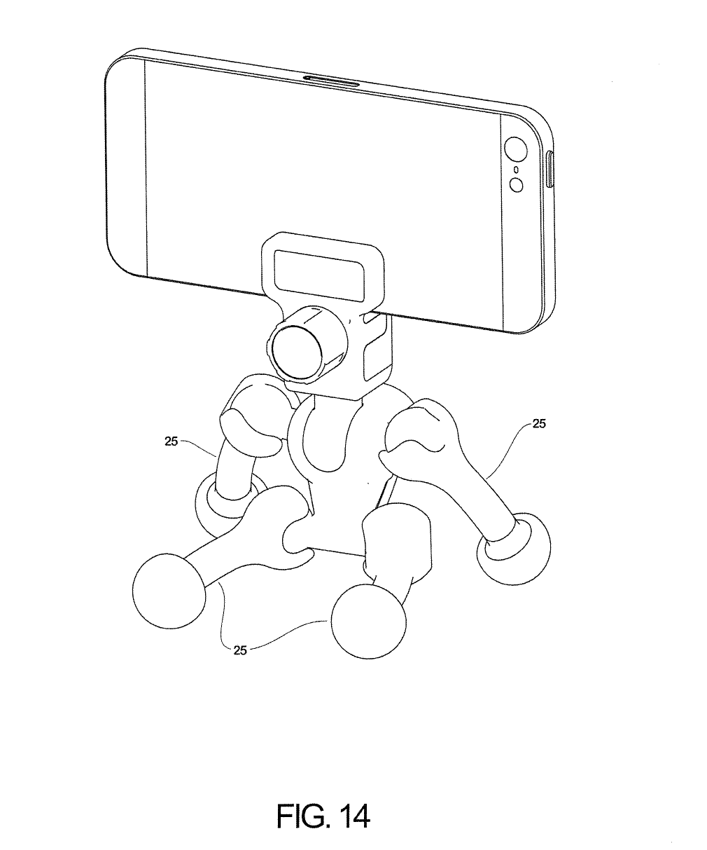

FIGS. 10a and 10b, illustrate two of many different ways support A can be attached to the back of different types of chairs. FIG. 11, illustrates a configuration of support A where two links 25 each grip the device being held by support A and provide a contact juncture with the support surface. FIG. 12 illustrates a configuration of support A in which two links 25 each grip a lower portion of the device being held by support A and provide a contact juncture with the support surface and a third link 25 grips an upper portion of the device. FIGS. 11 and 12 illustrate configurations in which the attachment member 15 is not used to secure the device being supported by support A. FIGS. 13 and 14 illustrate different configurations for support A where each of the appendages C includes only link 25.

The components of support A are preferably formed from an elastomer material that will keep its shape under the weight of the article being supported. However, it will readily appreciated that any suitable material may be used.

While this invention has been described as having a preferred design, it is understood that the preferred design can be further modified or adapted following in general the principles of the invention and including but not limited to such departures from the present invention as come within the known or customary practice in the art to which the invention pertains. The claims are not limited to the preferred embodiment and have been written to preclude such a narrow construction using the principles of claim differentiation.

We claim:

1. An apparatus for supporting an article in a free standing manner so that the article can be used by an individual without the individual supporting the article, said apparatus comprising:
(a) a support having a body and a plurality of appendages, the support being configured to position an article in a free standing manner so that the article can be used by an individual without the individual holding the article;
(b) said body having a plurality of connection areas, each of the plurality of appendages having at least one connection area so that each of the plurality of appendages can be detachably connected to one of the plurality of connection areas of said body; and,
(c) at least one of said plurality of appendages being connected to said body so that the at least one of the plurality of appendages can be moved between a first position and a second position, in the first position the at least one of said plurality of appendages grips a portion of the article and in the second position the at least one of said plurality of appendages contacts a surface on which said support is mounted.

2. An apparatus as recited in claim 1, wherein:
(a) said body includes a body section and a neck portion, said neck portion includes a first connector, said neck portion being operably connected to said body section and moveable relative to said body section.

3. An apparatus as recited in claim 2, wherein:
(a) said neck portion includes a ball joint having an aperture extending through the ball joint and an elongated member extending through said aperture, said elongated member having a threaded portion; and,
(b) a positioning member operably associated with said ball joint to lock in place said ball joint at a plurality of different positions, said positioning member being moveable between a first position and a second position, in said first position said ball joint is free to move relative to said body section and in the second position said ball joint cannot move relative to said body section.

4. An apparatus as recited in claim 3, wherein:
(a) said positioning member includes a lever pivotally mounted to said body section so that said lever can pivot relative to said body section; and,
(b) an intermediate member positioned between said ball joint and said lever, said intermediate member is configured to receive at least a portion of said ball joint.

5. An apparatus as recited in claim 1, wherein:
(a) each of said plurality of connection areas of said body are one of a ball and a socket; and,
(b) each of said plurality of connection areas of said plurality of appendages are one of a ball and a socket.

6. An apparatus as recited in claim 5, wherein:
(a) each of said plurality of connection areas of said body are a ball; and,
(b) each of said plurality of appendages include at least one ball and at least one socket, the at least one socket of each of the plurality of appendages engages a corresponding ball of said body to allow each of the plurality of appendages three rotational degrees of freedom relative to said body.

7. An apparatus, as recited in claim 6, wherein:
(a) each socket of each of the plurality of appendages includes at least two slots.

8. An apparatus for supporting an article in a free standing manner so that the article can be used by an individual without the individual supporting the article, said apparatus comprising:
(a) a support having a body and a plurality of appendages, the support being configured to position an article in a free standing manner so that the article can be used by an individual without the individual holding the article;
(b) said body having a plurality of connection areas, each of the plurality of appendages having at least one connection area so that each of the plurality of appendages can be detachably connected to one of the plurality of connection areas of said body; and,
(c) said plurality of connection areas of said body and said plurality of connection areas of said appendages being configured so that the position of said body and said appendages can be readily varied to allow said support to support at least one of the following: (i) a plurality of articles where each of the plurality of articles has a different size; and (ii) a plurality of articles where each of the plurality of article has a different shape.

9. An apparatus as recited in claim 8, wherein:
(a) said support includes four appendages detachably connected to said body; and, the article is an electronic device having at least one of a display screen, a radio and a camera.

10. An apparatus as recited in claim 10, wherein:
(a) each of said four appendages includes a first link and a second link, said first link being detachably connected to said second link, said first link further being detachably connected to said body.

11. An apparatus as recited in claim 10, wherein:
(a) each of said first link and said second link include a ball and a socket and a mid-section connecting said ball to said socket.

12. An apparatus as recited in claim 11, wherein:
(a) said mid-section has a length equal to or greater than each of a length of said ball and a length of said socket, said ball and said socket have a width greater than the width of said mid-section.

13. An apparatus as recited in claim 11, wherein:
(a) said body and four appendages are connected to each other so that said body and said four appendages can be configured such that second link of two of the appendages has first and second contact junctures with a first support surface on which the support is mounted, the first contact juncture is spaced from the second contact juncture.

14. An apparatus as recited in 13, wherein:
(a) each of the two second links of the two appendages having the first and second contact junctures extends substantially horizontally.

15. An apparatus for supporting an article in a free standing manner so that the article can be used by an individual without the individual supporting the article, said apparatus comprising:
(a) a support having a body and a plurality of appendages, the support being configured to position an article in a free standing manner so that the article can be used by an individual without the individual holding the article;
(b) said body having a plurality of connection areas, each of the plurality of appendages having at least one connection area so that each of the plurality of appendages can be connected to one of the plurality of connection areas of said body;
(c) said plurality of connection areas of said body and said plurality of connection areas of said appendages being configured so that the position of said body and said appendages can be readily varied to vary the number of contact junctures between said support and a support structure upon which said support is mounted; and,
(d) at least one of said plurality of appendages including a plurality of detachably connected links so that the length of the at least one of the plurality of appendages can be readily varied.

16. An apparatus as cited in claim 15, wherein:
(a) said support includes four appendages connected to said body so that each of said four appendages has at least two degrees of rotational freedom relative to said body; and,
(b) an adjustable clamp detachably connected to said body for receiving at least a portion of the article and holding the article in a desired position.

17. An apparatus as recited in claim 16, wherein:
(a) each of said four appendages includes a first link detachably connected to a second link.

18. An apparatus as recited in claim 17, wherein:
(a) said first link of each of said four appendages is connected to the corresponding second link so that the corresponding second link can rotate relative to the corresponding first link.

19. An apparatus for supporting an article in a free standing manner so that the article can be used by an individual without the individual supporting the article, said apparatus comprising:
(a) a support having a body and a plurality of support appendages such that at least one of the plurality of support appendages has at least two rotational degrees of freedom relative to said body, the support being configured to position an article in a free standing manner so that the article can be used by an individual without the individual holding the article;
(b) each of said plurality of support appendages being adjustable relative to said body to allow an individual to vary the configuration of said support; and,
(c) at least one of said plurality of support appendages being configured to be moveable between a first support position and a second support position, in the first support position the at least one of the said plurality of support appendages has at least one more contact juncture with a first support structure on which the support is mounted than when said at least one of said plurality of support appendages is in the second support position.

20. The apparatus as recited in claim 19, wherein:
(a) said support includes four appendages, each of said four appendages has three rotational degrees of freedom relative to said body; and,
(b) each of said four appendages includes a first link connected to a second link, the first link is further connected to said body, each of said second links has three rotational degrees of freedom relative to the corresponding first link.

21. The apparatus as recited in claim 19, wherein:
(a) each of said four appendages are configured to be able to serve as an arm and a leg depending upon how said support is configured.
